(19) United States
(12) Patent Application Publication
(10) Pub. No.: US 2025/0231406 A1
(43) Pub. Date: Jul. 17, 2025

(54) Compact Projector for Display System

(71) Applicant: DigiLens Inc., Sunnyvale, CA (US)

(72) Inventors: John Border, Sunnyvale, CA (US); Joe Bietry, Sunnyvale, CA (US); Alastair John Grant, San Jose, CA (US); Nima Shams, Sunnyvale, CA (US); Milan Momcilo Popovich, Leicester (GB); Nicholas Sherwood, Sunnyvale, CA (US)

(73) Assignee: DigiLens Inc., Sunnyvale, CA (US)

(21) Appl. No.: 18/702,763

(22) PCT Filed: Oct. 18, 2022
(86) PCT No.: PCT/US2022/078269

§ 371 Date: Apr. 18, 2024

Related U.S. Application Data
(60) Provisional application No. 63/262,671, filed on Oct. 18, 2021.
(60) Provisional application No. 63/366,735, filed on Jun. 21, 2022.

(51) Int. Cl. G02B 27/01; G02B 27/28

(52) U.S. Cl. CPC G02B 27/0172; G02B 27/283; G02B 2027/0174; G02B 2027/0178

(57) ABSTRACT

Disclosed herein is a compact projector for display systems. In various embodiments, the projector may include a light source, a first reflective polarizer, a reflective image modulator, a set of one or more lenses positioned along a first optical axis between the first reflective polarizer and the reflective image modulator, and a display system. The light source may output illuminating light which at least partially passes through the first reflective polarizer and is focused by the set of one or more lenses to provide telecentric illumination with a narrow cone angle onto the reflective image modulator. The illuminating light may be reflected by the reflective image modulator to form image containing light which is focused by the set of one or more lenses, and the image containing light may be reflected by the first reflective polarizer to provide an input to the display system.

### CROSS-REFERENCED APPLICATIONS

This application claims priority to U.S. Provisional Application No. 63/262,671 filed on Oct. 18, 2021 and U.S. Provisional Application No. 63/366,735 filed on Jun. 21, 2022, the disclosures of which are incorporated by reference in their entirety.

### FIELD OF THE INVENTION

The present invention generally relates to projector systems and more specifically to projector systems incorporated into head worn augmented reality displays incorporating waveguide-based displays.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within or on the surface of the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal (LC) micro-droplets, interspersed with regions of clear polymer. The alternating liquid crystal-rich and liquid crystal-depleted regions form the fringe planes of the grating.

Waveguide optics, such as those described above, can be considered for a range of display systems and sensor applications. In many applications, waveguides containing one or more grating layers encoding multiple optical functions can be realized using various waveguide architectures and material systems, enabling new innovations in near-eye displays for Augmented Reality (AR) and Virtual Reality (VR), compact Heads Up Displays (HUDs) for aviation and road transport, and sensors for biometric and laser radar (LIDAR) applications. As many of these applications are directed at consumer products, there is a growing requirement for efficient low cost means for manufacturing holographic waveguides in large volumes.

In near-eye displays and display devices it may be beneficial that the overall system including a waveguide and a projector be compact and light weight to enable the user to wear the near-eye display comfortably and to enable the user to perform different tasks in environments where the user moves.

### SUMMARY OF THE INVENTION

Various embodiments are directed to a projector device for displaying an image including: a light source; a first reflective polarizer; a reflective image modulator; a set of one or more lenses positioned along a first optical axis between the first reflective polarizer and the reflective image modulator; and a display system. The light source may output illuminating light which at least partially passes through the first reflective polarizer and is focused by the set of one or more lenses to provide telecentric illumination with a narrow cone angle onto the reflective image modulator. The illuminating light may be reflected by the reflective image modulator to form image containing light which is focused by the set of one or more lenses, and wherein the image containing light is reflected by the first reflective polarizer to provide an input to the display system.

In various other embodiments, the illuminating light passes through the set of one or more lenses to focus onto the reflective image modulator and the image containing light passes back through the set of one or more lenses to provide a focused image as an input to the display system.

In still various other embodiments, the light source includes one or more LEDs each with cone angles of less than +/−15 degrees.

In still various other embodiments, the light source includes one or more lasers.

In still various other embodiments, the light source includes a diffuser to increase the cone angle of the illuminating light to match a cone angle of the image containing light at the reflective polarizer.

In still various other embodiments, the diffuser is a holographic diffuser.

In still various other embodiments, the holographic diffuser is a flat top diffuser that provides a rectangular illumination pattern.

In still various other embodiments, the illumination pattern substantially matches an active area of the reflective image modulator.

In still various other embodiments, the light source includes an X-cube with multiple light sources that are directed by the X-cube to provide a common path and common cone angle of illuminating light for all the light sources at the reflective polarizer.

In still various other embodiments, the multiple light sources are red, green and blue LEDs and the X-cube includes dichroic coatings.

In still various other embodiments, the projector device includes a controller that sequentially operates the LEDs to provide sequential red, green, and blue illumination of the reflective image modulator.

In still various other embodiments, the controller adjusts the brightness and duty cycle of the LEDs to produce colors perceived by a user that are associated with portions of the image.

In still various other embodiments, the reflective polarizer is a wire grid polarizer.

In still various other embodiments, the reflective polarizer is oriented at 45 degrees to a common optical axis between the light source and the reflective image modulator thereby folding the optical path of the image containing light.

In still various other embodiments, the reflective polarizer is oriented with the reflective side facing the reflective image modulator.

In still various other embodiments, the display system includes a waveguide.

In still various other embodiments, the projector device further comprises a set of one or more output lenses positioned along a second optical axis on the folded optical path for the image containing light between the first reflective polarizer and the display system.

In still various other embodiments, the set of one or more lenses and the set of one or more output lenses together collimate the image containing light from said reflective image modulator and project light reflected from each pixel of the reflective image modulator into a unique portion of the displayed FOV.

In still various other embodiments, the first optical axis and the second optical axis are perpendicular to each other.

In still various other embodiments, the set of one or more lenses and the set of one or more output lenses include at least one selected from the group of a spherical surface, an aspheric surface, and a diffractive optical surface.

In still various other embodiments, the first reflective polarizer reflects light of a first polarization and transmits light of a second polarization, and wherein the reflective image modulator transforms light from light of the second polarization to light of the first polarization in correspondence to image content.

In still various other embodiments, the light source outputs light with P polarization, the first reflective polarizer transmits the P-polarized light, the reflective image modulator transforms the P-polarized light into S-polarized light in correspondence with image content which is reflected by the first reflective polarizer.

In still various other embodiments, the light source outputs light with S polarization, the first reflective polarizer transmits the S-polarized light, the reflective image modulator transforms the S-polarized light into P-polarized light in correspondence with image content which is reflected by the first reflective polarizer.

In still various other embodiments, the light source is configured to output red, green, and blue light.

In still various other embodiments, the light source includes a red LED, a green LED, and a blue LED.

In still various other embodiments, the light source further includes a light combiner and wherein the red LED, the green LED, and the blue LED are positioned to output different colors of light onto different faces of the light combiner.

In still various other embodiments, the light combiner is an X-cube.

In still various other embodiments, the combined different colors of light are output from a unique face of the light combiner as white light.

In still various other embodiments, the projector device further includes a diffuser positioned between the light combiner and the first reflective polarizer.

In still various other embodiments, the diffuser is attached to the output face of the light combiner.

In still various other embodiments, the projector device further includes an absorptive polarizer disposed on the output face of the light combiner.

In still various other embodiments, the projector device further includes: a quarter waveplate positioned between the first reflective polarizer and the light combiner; a first mirror positioned above the first reflective polarizer; and a plurality of mirrors surrounding the light combiner with apertures which correspond to the positioning of the red LED, the green LED, and the blue LED. The light may be: rotated within the quarter waveplate, at least partially reflected off the first reflective polarizer, wherein the first reflective polarizer transmits a first linear polarization of light and reflects a second linear polarization of light, reflected off the first mirror, reflected again off the first reflective polarizer, rotated within the quarter waveplate into circularly polarized light, reentered into the light combiner where the light is reflected off at least one of the plurality of mirrors reversing the direction of the circularly polarized light, rotated within the quarter waveplate into the second linear polarization of light, and transmitted through the first reflective polarizer.

In still various other embodiments, the projector device further includes: a film stack including: a diffuser, a second reflective polarizer, and a quarter waveplate positioned between the light combiner and the first reflective polarizer; and a plurality of mirrors surrounding the light combiner with apertures which correspond to the positioning of the red LED, the green LED, and the blue LED. The light may be: rotated within the quarter waveplate, at least partially reflected off the second reflective polarizer, wherein the second reflective polarizer is configured to transmits a first linear polarization of light and reflects a second linear polarization of light, rotated within the quarter waveplate into circularly polarized light, reentered into the light combiner where the light is reflected off at least one of the plurality of mirrors reversing the direction of the circularly polarized light, rotated within the quarter waveplate into the first linear polarization of light, transmitted through the second reflective polarizer, diffused through the diffuser, and passed through the first reflective polarizer.

In still various other embodiments, the first reflective polarizer and the second reflective polarizer are configured to transmit the same polarization of light.

In still various other embodiments, the first reflective polarizer and the second reflective polarizer are configured to reflect the same polarization of light.

In still various other embodiments, the second reflective polarizer is curved and the diffuser is conformally coated to the curved second reflective polarizer.

In still various other embodiments, the reflective image modulator includes a liquid crystal on silicon (LCoS) spatial light modulator.

In still various other embodiments, the projector device further includes an absorptive polarizer positioned between the light source and the first reflective polarizer.

In still various other embodiments, the absorptive polarizer is positioned on a surface of the first reflective polarizer facing the light source.

In still various other embodiments, the first reflective polarizer and absorptive polarizer are configured to transmit the same polarization of light.

In still various other embodiments, the projector device further includes an absorptive polarizer positioned in the path of the image containing light that is reflected by the first reflective polarizer.

In still various other embodiments, the absorptive polarizer is configured to transmit the same polarization of light as the reflective polarizer is configured to reflect.

In still various other embodiments, the display system includes a waveguide including an input grating configured to input image containing light into total internal reflection within the waveguide.

Various further embodiments are directed to a device for providing polarized light including: a light source which outputs unpolarized light; a reflecting surface associated with the light source that also at least partially depolarizes; and a reflective polarizer. A first portion of the unpolarized light from the light source may include a first polarization state that is transmitted by the reflective polarizer and a second portion of the unpolarized light including a second polarization state that is reflected by the reflective polarizer. The reflected second portion may then be reflected and depolarized by the reflecting surface to form recycled light comprising light with both the first polarization state and the second polarization state. Portions of the recycled light may then be transmitted and reflected by the reflective polarizer in correspondence to their polarization state thereby increasing the transmitted light with the first polarization state.

In various other embodiments, the device further includes a polarization conversion film between the light source and the reflective polarizer.

In still various other embodiments, the polarization conversion film is a quarter wave film.

In still various other embodiments, the polarization conversion film is a depolarizing film.

In still various other embodiments, the light source is an LED.

In still various other embodiments, the device further includes a lens.

In still various other embodiments, the reflective polarizer is positioned between the light source and the lens.

In still various other embodiments, the reflective polarizer is positioned above the lens.

In still various other embodiments, the reflective polarizer is curved.

In still various other embodiments, the curve is a simple curve.

In still various other embodiments, the curve is a spherical curve.

In still various other embodiments, the curve is an aspheric curve.

In still various other embodiments, the lens is a compound parabolic reflector.

In still various other embodiments, the light source and lens are a bonded light assembly and the light source is aligned relative to the lens.

In still various other embodiments, the lens is birefringent.

In still various other embodiments, the lens is a catadioptric lens.

In still various other embodiments, the reflective polarizer is positioned within 100 microns of the light source.

In still various other embodiments, the reflecting surface has a surface roughness that is greater than 100 Angstroms.

In still various other embodiments, the reflective polarizer has an extinction ratio of greater than 100:1.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIG. 1 illustrates a schematic of a projector in accordance with an embodiment of the invention.

FIG. 2 illustrates the operation of the projector described in connection with FIG. 1.

FIG. 3 illustrates a schematic of a projector integrated with a waveguide in accordance with an embodiment of the invention.

FIG. 4 illustrates an enlarged schematic of the light source in accordance with an embodiment of the invention.

FIG. 5 illustrates a projector including a diffuser in accordance with an embodiment of the invention.

FIG. 6 illustrates a projector including one or more clean up polarizers in accordance with one or more embodiments of the invention.

FIG. 7 illustrates a schematic of the projector described above integrated within a head worn waveguide-based display in accordance with an embodiment of the disclosure.

FIG. 8 illustrates the operation of a projector where the light source outputs unpolarized light.

FIG. 9 schematically illustrates the operation of a polarized light recycling system in accordance with various embodiments of the invention.

FIG. 10 schematically illustrates a projector with a polarized light recycling system in accordance with an embodiment of the invention.

FIG. 11 schematically illustrates a projector in accordance with an embodiment of the invention.

FIG. 12 schematically illustrates an LED assembly in accordance with an embodiment of the invention.

FIGS. 13A-13G illustrate various embodiments of an LED assembly including a light recycling system.

FIG. 14 illustrates a polarization recycling system integrated into a projector with multiple LEDs.

FIG. 15 illustrates a schematic of a projector including a polarized light recycling system in accordance with an embodiment of the invention.

FIG. 16A illustrates a schematic of a projector including a light recycling system in accordance with an embodiment of the invention.

FIG. 16B illustrates a light recycling system in accordance with an embodiment of the invention.

### DETAILED DESCRIPTION

A head worn display device may include a projector device which injects light into one or more waveguides which output image light including image content into a user's eyes. It may be advantageous for the projector to be of a small form factor to allow the head worn display device to be comfortably worn on a user's head, particularly when the user is moving. However, typically, display devices take up a certain amount of space which may make the display devices bulky and unwieldy. Thus, it is advantageous for the projector to have a small form factor.

Various embodiments of the disclosed technology relate to a small form factor projector which utilizes a folded optical path to reduce the overall size of the projector. The folded optical path is provided by reflections from a reflective polarizer and a reflective image modulator. Along the folded optical path, light from a light source passes through one or more lenses that focuses illuminating light onto the reflective image modulator to provide telecentric illumination. The illuminating light is reflected by the reflective image modulator in such a way that image content is introduced thereby providing image light. The image light then passes back through the one or more lenses that focus the image light for presentation to a waveguide. As such, the one or more lenses first act on the illuminating light to provide telecentric illumination of the reflective image modulator and then secondly act on the image light to focus the image light for presentation to the waveguide. By providing telecentric illumination of the reflective image modulator, high contrast is ensured within the image light with good uniformity across the field of view when the image light is presented by the waveguide to the user's eye. By folding the optical path and by using the one or more lenses to act on both the illuminating light and the image light the form factor of the projector can be substantially reduced.

Further, various embodiments of the disclosed technology include a set of one or more output lenses positioned between the waveguide and the reflective polarizer. Where the set of one or more output lenses further focuses the image light, thereby enabling more optical power to be applied and the field of view to be expanded. The one or more output lenses may be a doublet or triplet lens to reduce surface reflection losses to improve efficiency and also to enable color correction for improved image quality with reduced color artifacts.

Various embodiments of the disclosed technology also include polarization recycling. Polarization recycling increases efficiency in illumination systems that utilize unpolarized light sources such as LEDs to provide polarized illuminating light to image sources that require polarized light such as LCOS display systems. Efficiency improvements of >20% may be provided. Polarization recycling may occur in a location within the illumination system where the illuminating light is collimated and the area is large so that the reflected recycled light is returned to a large scattering layer. Collimating the light and using a large area reduces losses of the reflected recycled light to the sidewalls of the illumination system. As such, the illumination system may include a light source that feeds into a collimation system prior to the polarization recycling system. However, this configuration of the illumination system may be large. High brightness LEDs typically don't include a lens so the cone angle from the emitting surface may be 100-140 degrees. Various embodiment of the invention include a polarization recycling system that is compact by associating the polarization recycling with an LED assembly.

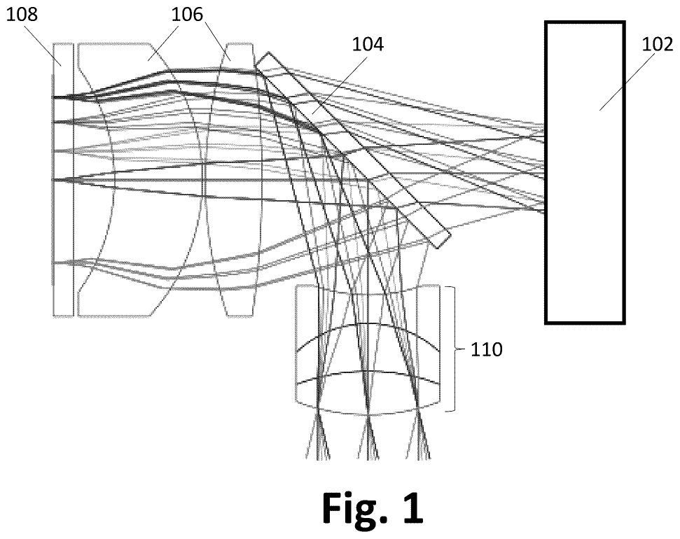

Turning now to the figures, FIG. 1 illustrates a schematic of a projector in accordance with an embodiment of the invention. The projector includes a light source 102 which provides light to a reflective polarizer 104. The reflective polarizer 104 can be a wiregrid polarizer such as is available from Moxtek (Orem, UT) or a multilayer film such as is available from 3M (Saint Paul, MN). The reflective polarizer 104 is configured to transmit a first polarization light and reflect a second polarization light. The first polarization light and second polarization light may be of orthogonal polarization. The light from the light source 102 may include light including both the first polarization and the second polarization (also known as unpolarized light), where the first polarization light is transmitted through the reflective polarizer 104 to one or more lenses 106. For example, the reflective polarizer 104 may be configured to reflect S polarized light and transmit P polarized light. The transmitted first polarization light passes through one or more lenses 106 to illuminate a reflective image modulator 108 which reflects the illuminating light by converting the light, by degrees, from the first polarization to the second polarization in relation to image content. For example, the reflective image modulator 108 may convert the P polarized light into S polarized light which contains image data.

The one or more lenses 106 are positioned between the reflective polarizer 104 and the reflective image modulator 108. There may be one or more output lenses 110 positioned between the reflective polarizer 104 and the waveguide. The one or more lenses 106 first receive the light from the light source 102 that has been transmitted through the reflective polarizer 104 where the one or more lenses 106 focus the light to provide telecentric illuminating light with a narrow cone angle to the reflective image modulator 108. The one or more lenses 106 cooperate with the one or more output lenses 110 to form a projection lens that collimates the light from each pixel of the reflective light modulator 108 and projects the collimated light from each pixel into a unique portion of the displayed field of view (FOV).

In some embodiments, the one or more output lenses 110 may not be present when the one or more lenses 106 are sufficient to collimate the light from the reflective light modulator 108. However, this may result in reduced optical power and consequently a smaller field of view and insufficient space for interfacing the projector to the waveguide. Another consequence may be that the number of lens elements in the one or more output lenses 106 may need to increase to correct lens aberrations.

The illuminating light is then reflected by the reflective image modulator 108 to create image light as described previously. However, conversion of polarization in general by absorptive polarizers, reflective polarizers, LCOS, and polarizing coatings, may be sensitive to the angle of incidence of the light. Consequently, the conversion of the polarization of the illuminating light to the polarization of the image light in relation to image content, is more uniform because the illuminating light ray bundles have a uniform central angle, due to the illumination being telecentric, and the variation of angle within the ray bundles is reduced because the illuminating light has a narrow cone angle (e.g. less than +/−10 degrees).

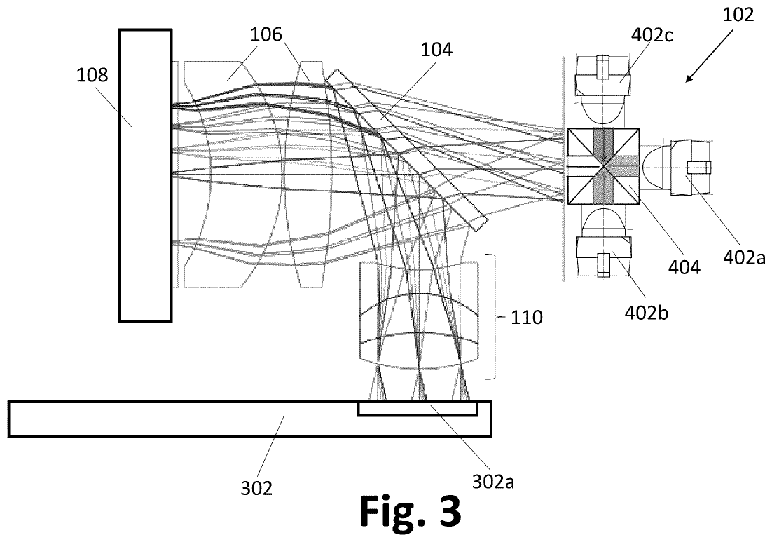

As can be seen, in FIG. 1, the illuminating light of the first polarization is transmitted by the reflective polarizer 104, this light is then reflected by the reflective image modulator 108 to form image light comprised of a mix of first and second polarization in relation to the image content. The image light with the second polarization is then reflected by the reflective polarizer 104 so that the image light travels through output lenses 110 and toward a waveguide. The image light may thereby be focused by both the one or more lenses 106 and the one or more output lenses 110 to provide image light for the waveguide that is of high contrast and collimated to a level required for efficient beam propagation within the waveguide, as shown in FIG. 3. In some embodiments, the reflective image modulator 108 may be a liquid crystal on silicon (LCoS) spatial light modulator. In some embodiments, the reflective image modulator 108 may include a MEMS based display device such as a digital light processing (DLP). When the reflective image modulator 108 is a MEMS based display device, the reflective image modulator 108 may include more prismatic elements to produce angular separation of the illumination and projection paths in the MEMS display device.

As discussed previously, after being reflected by the reflective polarizer 104, the image light with the second polarization may pass through one or more output lenses 110. The one or more output lenses 110 may include multiple elements such as in a doublet or triplet lens. The multiple elements in the one or more output lenses 110 may be bonded together as shown in FIG. 1 to eliminate air gaps between lens elements thereby reducing losses due to surface reflections. The addition of the one or more output lenses 110 allows the projector to apply more optical power to the image light so that a larger field of view can be provided in the displayed image seen by the user. Also, by including multiple elements in the output lens 110, color related artifacts can be corrected by using different materials with different refractive indices and different levels of dispersion. The one or more output lenses 110 may include refractive, aspherical, and diffractive surfaces. In some embodiments, the one or more output lenses 110 may include multiple lens elements that may be used to correct monochromatic aberrations that might impact on collimation and other optical aberrations such as geometrical distortion. In some embodiments, one or more diffractive optical surfaces may be included with the one or more output lenses 110 to reduce the number of elements required to corrector color and monochromatic aberration.

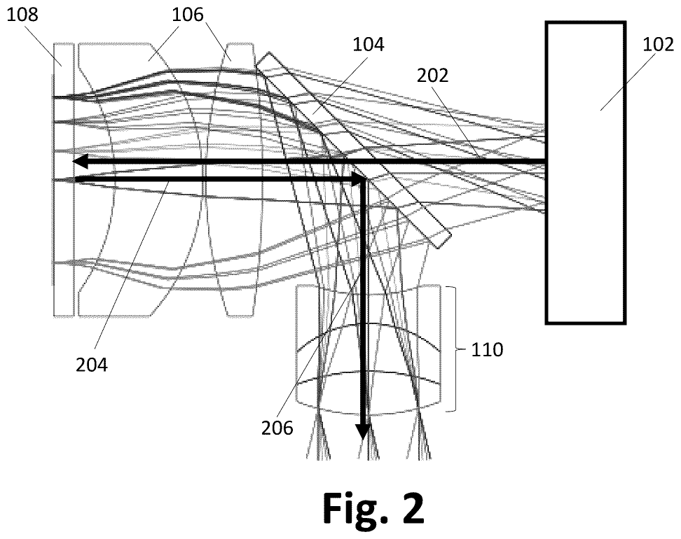

FIG. 2 illustrates the operation of the projector described in connection with FIG. 1. The light source 102 outputs illuminating light 202. The illuminating light 202 may include a first polarization light. The illuminating light 202 transmits through the reflective polarizer 104 and is focused by the one or more lenses 106 which have an effective focal length designed to provide telecentric illumination of the reflective light modulator 108. The light 202 is then modulated by the reflective light modulator 108 into image light 204 including a mix of first and second polarization light in correspondence to image content. The image light 204 is then focused by the one or more lenses 106 and the portion of image light 204 that is second polarization light is reflected by the reflective polarizer 104 as image light 206. The reflective polarizer 104 may be oriented at 45 degrees to the common optical axis that is shared by the light source 102 and the reflective image modulator 108. As can be seen in FIG. 2, the optical path followed by light 202, 204, 206, is folded multiple times thereby reducing the overall size of the projector. By reflecting the image light 204, the reflective polarizer 104 causes the optical axis of the outbound image light 206 to be perpendicular to the optical axis of image light 204. In some embodiments, image light 206 then passes through one or more output lenses 110. As presented in FIG. 2 and described herein, the one or more lenses 106 act on illumination light 202 and image light 204, while the one or more output lenses 110 act only on the image light 206. In addition, the reflective polarizer allows the illumination light 202 and image light 204 to share a common optical axis while redirecting image light 206 along a perpendicular optical axis that is shared by the one or more output lenses 110 and the input to the display system.

The light 202 output from the light source 102 may also include a second polarization light which may be reflected by the reflective polarizer 104. Various embodiments including recycling of the portion of light 202 having the second polarization are described below.

For the reflective polarizer 104 shown in FIG. 2, the angle of incidence for light 202 is between approximately 45°+/−25°. In some embodiments, the reflective polarizer 104 may be a wiregrid polarizer because this type of polarizer can handle a wide range of angles of incidence. Also, as can be seen in FIG. 2, the reflective polarizer 104 may be positioned so that the reflective side is located on the side facing the reflective image modulator 108 to avoid introducing astigmatism artifacts caused by variations in the optical path length of the image light 204 caused by the thickness of the reflective polarizer 104. Astigmatism artifacts are not a problem in light 202 produced by the light source 102 since this light doesn't have image content.

FIG. 3 illustrates a schematic of a projector integrated with a waveguide in accordance with an embodiment of the invention. The projector includes a light source 102. The light source 102 may include a first LED 402a, a second LED 402b, and a third LED 402c. The first LED 402a, the second LED 402b, and the third LED 402c may be of different colors such as green, red and blue. The first LED 402a, the second LED 402b, and the third LED 402c may be narrow beam LEDs which have a narrow beam output. The first LED 402a, the second LED 402b, and the third LED 402c output light into a light combiner 404. The light combiner 404 may be cube shaped. The light combiner 404 may be an X-cube which may combine the light of the first LED 402a, the second LED 402b, and the third LED 402c to produce a combined light with a combined color that may depend on the relative brightness of LEDs 402a, 402b and 402c. Where the combined light includes a single beam of light 202 with a combined color that can be any color in the rainbow including white. The X-cube may include four prisms that are cemented together to form two different intersecting internal planes with dichroic coatings on the internal planes that are designed to transmit one color band while reflecting another color band. For example, one dichroic coating can be designed to transmit green (e.g. 500 to 570 nm) and reflect red (e.g. 610 to 675 nm) while the other dichroic coating can be designed to transmit green and reflect blue (e.g. 450 to 475 nm). When these two dichroic coatings are applied to the intersecting internal planes in an X-cube and the LEDs are arranged as shown in FIG. 3, the X-cube will transmit light from the green LED 402a and reflect light from the red and blue LEDs 402b and 402c such that a combined single beam of light 202 is formed that is comprised of the combined light from all three LEDs.

The image light 206 from the projector may output into a waveguide 302. The waveguide 302 may include an input grating 302a which may redirect the image light 206 from the projector so that the image light 206 undergoes total internal reflection within the waveguide 302. In some embodiments, the input grating 302a may include a prism which is configured to couple light into the waveguide. In many embodiments, the prism can provide more efficiency coupling.

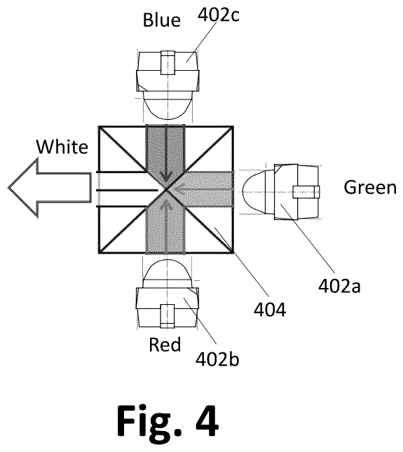

FIG. 4 illustrates an enlarged schematic of the light source 102 in accordance with an embodiment of the invention. As illustrated, the light source 102 may include separate red, blue, and green sources which combine within a light combiner 404 into a combined color light (e.g. white) which exits the light combiner 404 in a single beam. While LEDs are described and illustrated, it is understood that the red, blue, and green light sources may be other types of light sources as well, such as laser light sources. The first LED 402a, the second LED 402b, and the third LED 402c may all be positioned on different sides of the light combiner 404. The combined light may exit on a unique side of the light combiner 404.

In some embodiments, when using a reflective image modulator 108 to provide multiplied colored images, the illuminating light 202 may be sequentially modulated over time so that a series of individually colored images are presented to the user's eye. The projector may include a controller configured to control the first LED 402a, the second LED 402b, and the third LED 402c to sequentially modulate the output over time. As long as the rate of modulation is fast enough, the user may not be able to detect the individual colored images and instead perceives a combined image comprised of an overlaid combination of the individually colored images. For the case shown in FIG. 3, the LEDs (402a, 402b and 402c) may be sequentially used to illuminate the reflective image modulator 108 thereby producing sequential green, red and blue individually colored image light 206 to the waveguide 302 and each LED would provide light for only a portion of the total time (e.g. ⅓ of the total frame time for each color). So that the user perceives a combined image, the rate of modulation of the individually colored images may be greater than 60 times per second. In some embodiments, combined images or frames may be presented at a rate of greater than 30 times per second and the individually colored images or subframes may be presented at a faster rate, using multiple copies of each of the individually colored images. For example, individually colored images in red (designated R), green (designated G) and blue (designated B) can each be sequentially presented twice to form combined images 1, 2 and 3 as: R1-G1-B1-R1-G1-B1 in frame 1; R2-G2-B2-R2-G2-B2 in frame 2; R3-G3-B3-R3-G3-B3 in frame 3; etc. In this case, the light output shown in FIG. 4 represents the color of the combined image that is perceived by the user and white is an example for the perceived color that is produced with a relative R:G:B perceived brightness of 3:7:1, where perceived brightness can be a combination of actual brightness of the emitted light from an individual LED and the relative time that the individual LED provides light in each of the individually colored images (also known as duty cycle) or subframes. In some embodiments, Bragg gratings may be used to provide compact and efficient arrangements for collecting illumination from LEDs as disclosed in U.S. Pat. No. 8,634,120 entitled “Apparatus for condensing light from multiple sources using Bragg gratings” and filed Apr. 3, 2009 which is hereby incorporated by reference for all purposes.

The light emitted by the LEDs may be substantially unpolarized, and as such the light emitted includes a substantially equal amount of both polarizations. The X-cube coatings can be designed to reflect or transmit only one polarization, or the coatings can be designed to reflect or transmit both polarizations equally so that the polarization is not affected.

Advantageously, the light combiner 404 directs the light from each of the LEDs (402a, 402b and 402c) toward the reflective image modulator 108, so the light from each of the LEDs illuminates substantially the same portion of the reflective image modulator 108. In this way, the combined image perceived by the user has a uniform brightness pattern by color and has a correspondingly uniform color across the field of view according to the image content being displayed.

In addition, by including a light combiner 404, ultra-bright single color LEDs can be used to enable a brighter combined image. The fold of the optical path inside the light combiner 404 for two of the three LEDs (e.g. LEDs 402b and 402c as shown in FIG. 3) enables the projector to be more compact. Also, using single color LEDs that provide narrow cones of light, also known as a narrow viewing angle (e.g. between +/−15°), reduces the range of incidence angles that the dichroic coatings on the intersecting internal planes need to be designed for, which improves the uniformity of reflectivity and transmittivity of the coatings across the cone of light, to improve brightness uniformity across the field of view in the combined image seen by the user. Further, using LEDs with a narrow cone of light may reduce the size of the light combiner 404 which further reduces the size of the projector.

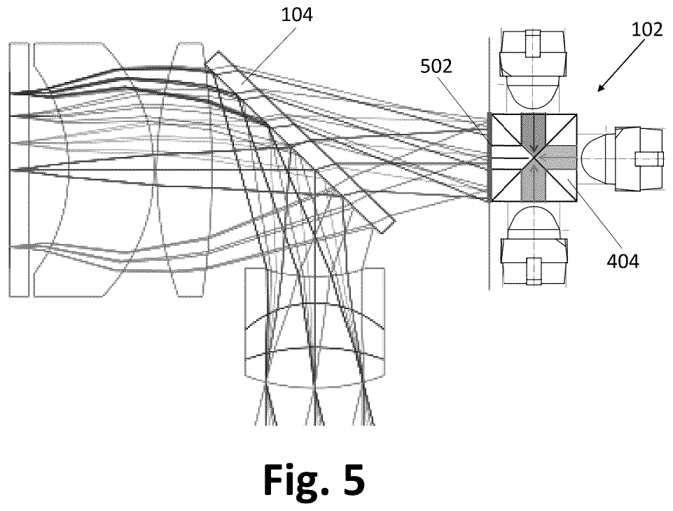

FIG. 5 illustrates a projector including a diffuser in accordance with an embodiment of the invention. This projector shares many features with the projector described in connection with FIGS. 1-4. The description of these features above are applicable to this projector as well and will not be repeated. As discussed above, the light source 102 may include a light combiner 404. A diffuser 502 may be positioned between the light source 102 and the reflective polarizer 104. In some embodiments, the diffuser 502 may be coated onto or attached to a surface of the light combiner 404. Advantageously, the diffuser 502 may be used to scatter the light from the light combiner 404 before reaching the reflective polarizer 104, thereby increasing the cone angle of the light 202 incident on the reflective polarizer 104. In some embodiments, the diffuser 502 is chosen to increase the cone angle of light 202 to substantially match the cone angle of the image light 204 at the reflective polarizer 104, as shown in FIG. 5. In some embodiments, the diffuser 502 may be a holographic diffuser and the use of LEDs with narrow cone angles enables the LEDs to work effectively with holographic diffusers that are designed for use with narrow cone angle light sources such as lasers. In some embodiments, the diffuser 502 is a top hat diffuser which provides a uniform brightness across the cone angle of light 202. In some embodiments, the diffuser 502 is a holographic top hat diffuser that provides a rectangular light pattern so that light 202 fully illuminates the active area of the reflective image modulator 108 with uniform brightness, while reducing illumination of portions of the reflective image modulator 108 outside of the active area. When using a holographic top hat diffuser that provides a rectangular light pattern, it is particularly advantageous to use LEDs with a narrow cone angle e.g. less than +/−15° or less than +/−10° to enable the light combiner 404 to be more compact, where the narrow cone angle of the LED may be produced by an LED that has microlens associated with it that focuses the LED light.

By selecting the diffuser 502 to increase the cone angle of light 202 to substantially match the cone angle of the image light 204 at the reflective polarizer 104, the path of the rays of light 202 can retrace the path of rays of image light 204 from the reflective polarizer 104 to the reflective image modulator 108. This allows the one or more lenses 106 to be designed to provide telecentric imaging with a narrow cone in imaging light 204. The light source 102 and diffuser 502 may match the angles of the rays of the image light 204 at the reflective polarizer 104 and thereby provide telecentric illumination with a narrow cone in light 202 at the reflective image modulator 108. Telecentric illumination with a narrow cone may reduce the effective distribution of polarization caused by angular effects as provided to the reflective image modulator 108. This telecentric approach with narrow cone angles may substantially improve image contrast and image uniformity across the field of view in the image presented to the user, because the polarization uniformity provided by the reflective image modulator 108 is improved. Alternatively, the cost of the reflective image modulator 108 can be reduced by this telecentric approach since the need for a compensator associated with the reflective image modulator 108 may not be needed to correct for a wide distribution of incident angles to improve polarization uniformity.

To ensure that the illumination provided by light source 102 covers the whole active area of the reflective image modulator 108, the light source 102 along with the diffuser 502 may be positioned at a certain distance from the reflective polarizer 104. In some embodiments, the distance between the reflective polarizer 104 and the diffuser 502 is the point where the area across the section of the cone of light 202 matches the area of the cone of image light 204 at the reflective polarizer 104. In FIG. 5, the rays of the illuminating light 202 are shown as substantially matching the rays of the subsequent image light 204 both in terms of angles and area at the reflective polarizer (note that there is a slight deviation of the light 202 as it passes through the reflective polarizer 104 due to refractive effects of the substrate).

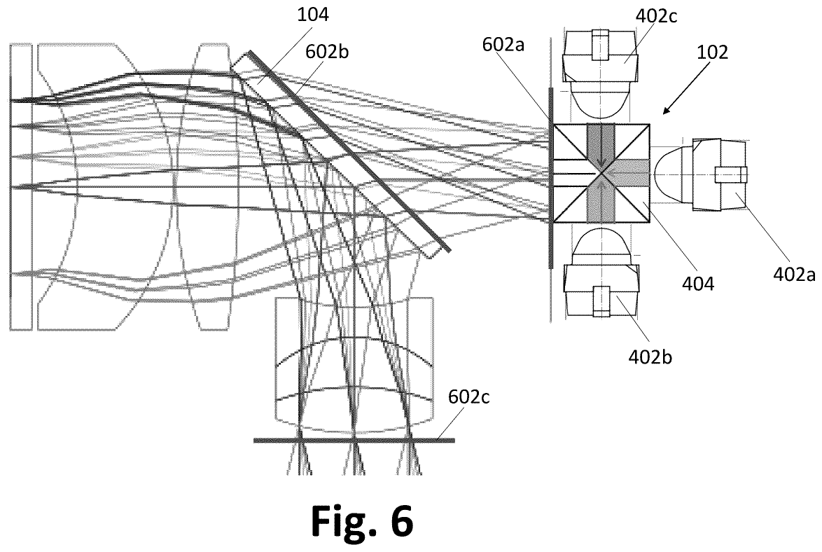

FIG. 6 illustrates a projector including one or more clean up polarizers in accordance with one or more embodiments of the invention. This projector shares many features with the projector described in connection with FIGS. 1-4. The description of these features above are applicable to this projector as well and will not be repeated. The light source 102 may include a light combiner 404. One or more absorptive polarizers 602a, and 602b may be positioned between the light combiner 404 and the reflective polarizer 104 to ensure that light 202 includes substantially one polarization when it is incident upon the reflective image modulator 108. In some embodiments, an absorptive polarizer 602a may be positioned on the exit surface of the light combiner 404. In some embodiments, an absorptive polarizer 602b may be positioned on the surface of the reflective polarizer 104 facing the light source 102. The one or more absorptive polarizers 602a, 602b are configured to transmit the polarization that the reflective polarizer 104 is configured to transmit and the reflective image modulator 108 is designed to reflect. The absorptive polarizers 602a, 602b absorb the other polarization so that stray light caused by reflection and scattering of light with the other polarization inside the projector is reduced thereby increasing contrast in the displayed image. Presenting illuminating light 202 with only one polarization also reduces stray light from the portion of image light that is not reflected by the reflective polarizer 104 so that the image light 206 includes light with one polarization and varying intensity corresponding to image content.

In some embodiments, the projector may include a further absorptive polarizer 602c in the path of image light 206 that has been reflected by the reflective polarizer 104. The absorptive polarizer 602c may be configured to transmit the same polarization of light that the reflective polarizer 104 is configured to reflect. The absorptive polarizer 602c may absorb any light with polarization that the reflective polarizer 104 is not configured to reflect. The extinction ratio of reflective polarizers is typically 50:1 while the extinction ratio of absorptive polarizer is typically 10,000:1 and as such the contrast of the image presented to the user may be improved with the addition of one or more absorptive polarizers 602a, 602b, 602c.

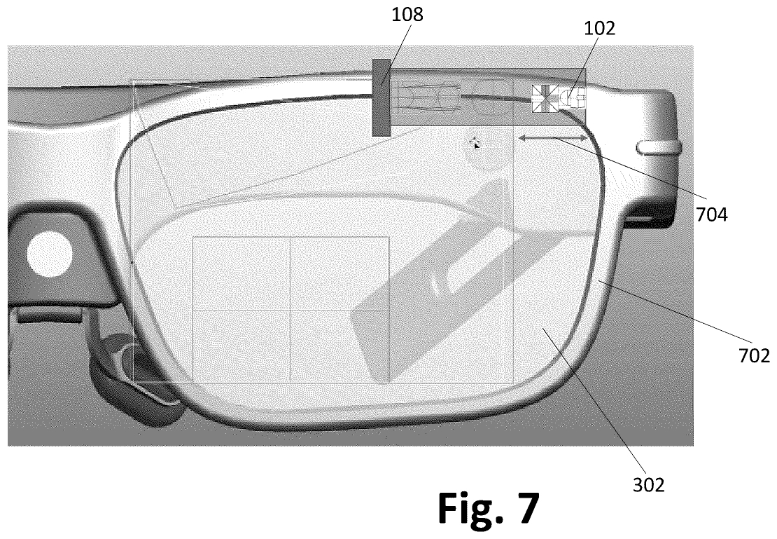

FIG. 7 illustrates a schematic of the projector described above integrated within a head worn waveguide-based display in accordance with an embodiment of the disclosure. As discussed above, the projector includes a light source 102 and a reflective image modulator 108. The light source 102 may include a dimension 704 which may be 8.9 mm. A waveguide 302 may be housed within a frame 702. The waveguide 302 receives light from the light source 102.

### Embodiments Including Light Recycling Systems

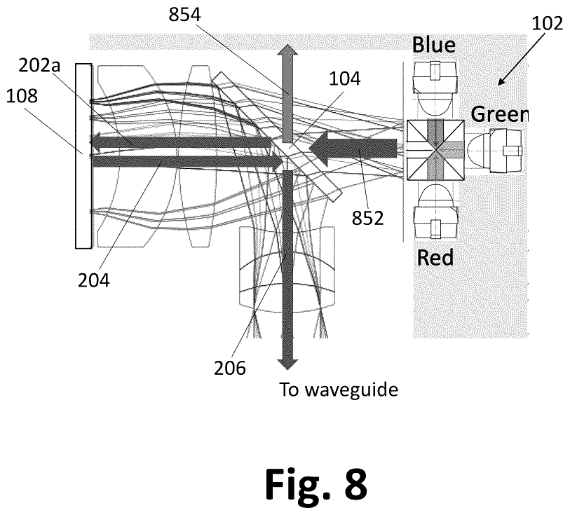

In some projector systems the light source 102 may output unpolarized light such that the reflective polarizer 104 transmits one polarization of light and reflects one polarization of light. The reflected polarization of light may be wasted. FIG. 8 illustrates the operation of a projector where the light source outputs unpolarized light. As illustrated, the light source 102 outputs unpolarized light 852. The unpolarized light 852 may include a first polarization light and a second polarization light. A first portion light 202a of the unpolarized light 852 is transmitted through the reflective polarizer 104. The first portion light 202a may include a first polarization of light. The first polarization light 202a is then modulated by the reflective light modulator 108 into image light 204 including a mix of first and second polarization light in correspondence to image content. The portion of image light 204 that is second polarization light is reflected by the reflective polarizer 104 as image light 206 which may be passed to a waveguide. The principles of this operation are described in connection with FIG. 2 which is applicable to the projector of FIG. 8. Further, FIGS. 1-7 describe additional features and components of the projector which may be applicable to the projector of FIG. 8. A second portion light 854 of the unpolarized light 852 is reflected by the reflective polarizer 104. This second portion light 854 may be wasted. The second portion light 854 may include a second polarization of light.

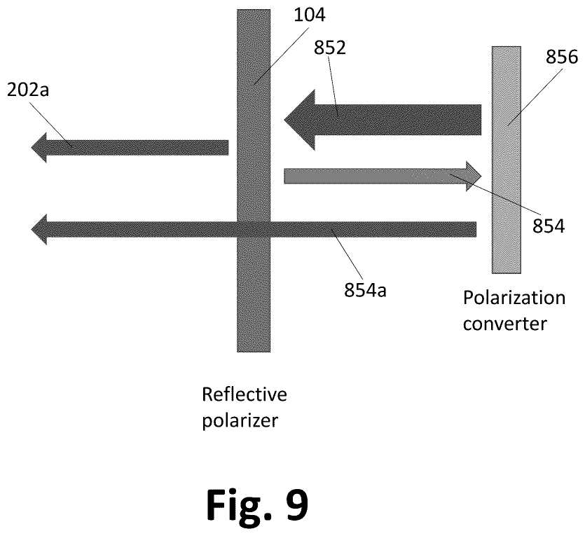

FIG. 9 schematically illustrates the operation of a polarized light recycling system in accordance with various embodiments of the invention. A reflective polarizer 104 may split the polarization states of the incident unpolarized light 852 (shown as the first portion light 202a and the second portion light 854) as discussed in connection with FIG. 8. A first portion light 202a of the incident light may be transmitted through the reflective polarizer 104 whereas the second portion light 854 of the incident light may be reflected by the reflective polarizer. To perform recycling, the second portion light 854 may be converted by a polarization converter 856 into converted light 854a. The converted light may have the same polarization as the first portion light 202a. The second portion 854 may be redirected through an imaging optics. The converted light 854a may be directed to be incident on the reflective polarizer 104 which may transmit the converted light 854a where it joins the first portion light 202a. As a result, brightness may be increased since the recycled converted light 854a adds to the originally transmitted first portion light 202a of the incident light that illuminates the reflective image modulator 108. The polarization converter 856 can be a quarter wave film that converts directly from one polarization state to the other polarization state when a portion of the light 854 is reflected by the surface of the light source. Similarly, in some embodiments, the polarization converter 856 can be a depolarizer.

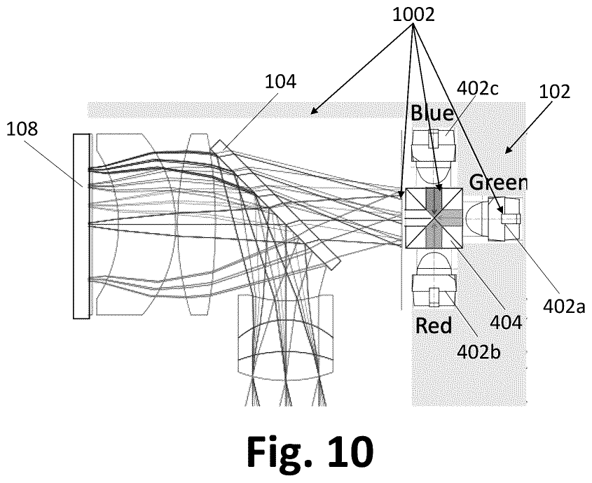

FIG. 10 schematically illustrates a projector with a polarized light recycling system in accordance with an embodiment of the invention. This projector shares many identically labeled components with the projector of FIGS. 1 and 3 and the description of these components will not be repeated in detail. In this embodiments, an additional reflective polarizer is added for polarization recycling that is located anyplace between the light source (e.g. LEDs 402a, 402b, 402c) and the reflective polarizer 104. The arrows 1002 indicate location for locating the reflective polarizer. The recycled light is reflected back through a diffuser 502 and a light combiner 404 to the LEDs 402a, 402b, 402c where it is reflected back toward the reflective polarizer 104. In some embodiments, a polarization converter can be included along the path such as a quarter wave plate. Alternately, the LEDs 402a, 402b, 402c may include a rough surface which may be a depolarizing reflector. The rough surface may be used to depolarize the light which is recycled. As illustrated, there are many locations for one or more reflective polarizers which may be used for polarization recycling.

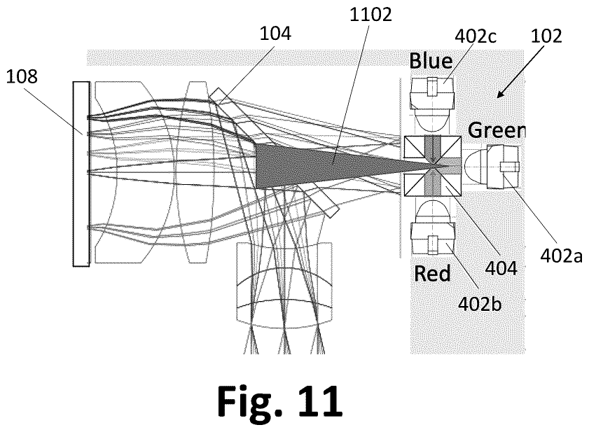

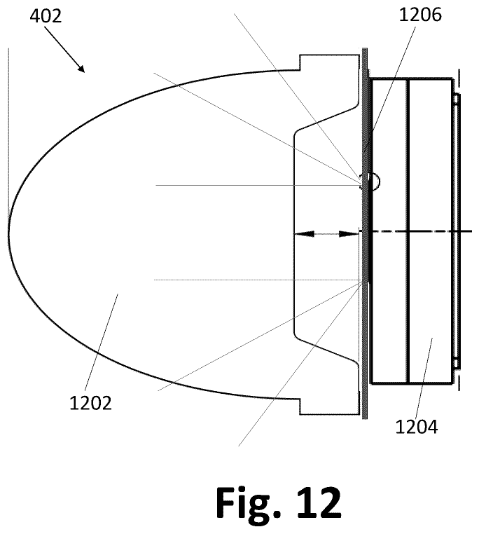

FIG. 11 schematically illustrates a projector in accordance with an embodiment of the invention. This projector shares many identically labeled components with the projector of FIGS. 1 and 3 and the description of these components will not be repeated in detail. As illustrated, the light source 102 may output light 1102 with a cone angle. In some examples, the cone angle may be 50 degrees. The spot size of the illumination light may increase further along the optical path. To reduce spreading of the illumination, the recycling may be performed as close as possible to the LEDs 402a, 402b, 402c. As illustrated, the LEDs 402a, 402b, 402c may include microlenses (illustrated in FIG. 12) positioned above the LEDs with the LED and microlens being separate components. As a result, some embodiments perform the recycling at the surface of the LED.

FIG. 12 schematically illustrates an LED assembly in accordance with an embodiment of the invention. The LED assembly 402 may be applicable to the LEDs 402a, 402b, 402c. The LED assembly 402 includes a microlens 1202 above an LED 1204. The LED 1204 outputs unpolarized light. The unpolarized light may include a first polarization light and a second polarization light. A recycling reflective polarizer 1206 may be positioned between the LED 1204 and the microlens 1202. The recycling reflective polarizer 1206 may transmit the same polarization light as the reflective polarizer 104 and may reflect the same polarization light as the reflective polarizer 104. The recycling reflective polarizer 1206 may reflect the second polarization light and transmit the first polarization light. The reflected second polarization light may be at least partially converted to the first polarization light and then redirected back into the recycling reflective polarizer 1206 to be transmitted.

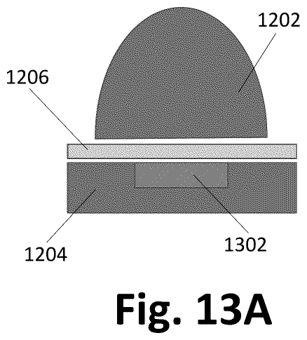

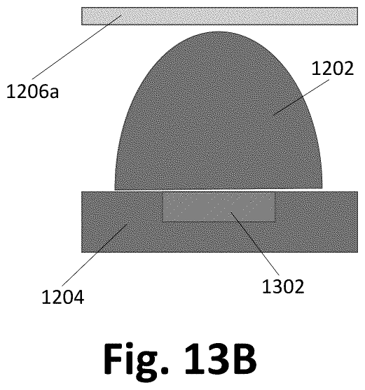

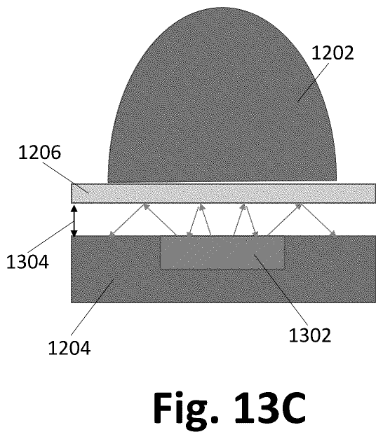

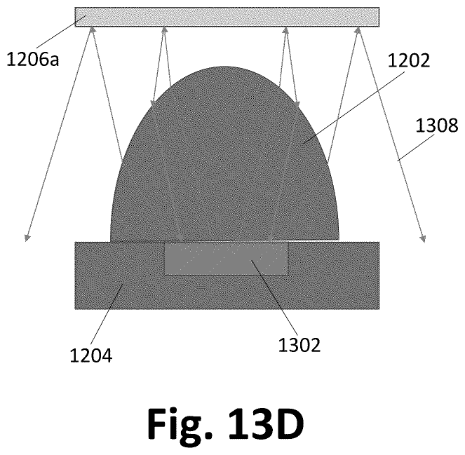

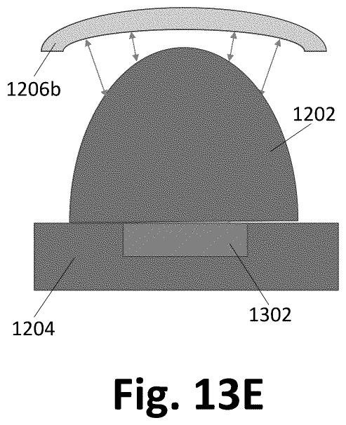

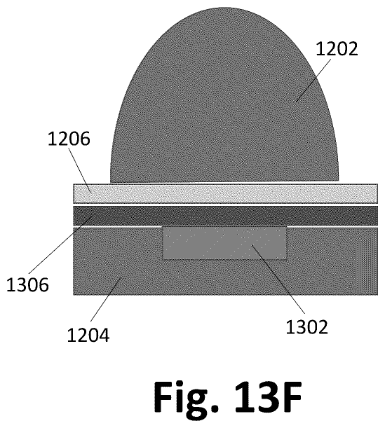

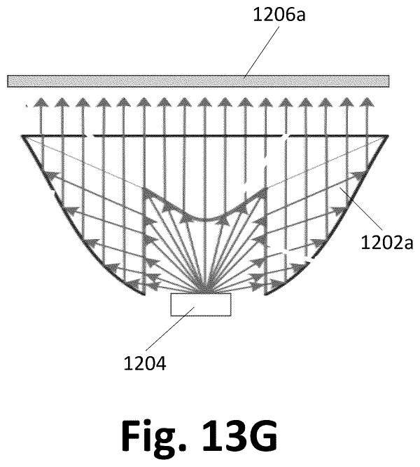

FIGS. 13A-13G illustrate various embodiments of an LED assembly including a light recycling system. As illustrated, an LED 1204 is positioned such than an LED emitting surface 1302 is configured to output unpolarized light towards a microlens 1202. A light recycling system may be created by including a recycling reflective polarizer. FIGS. 13A-13G illustrate various configurations including a recycling reflective polarizer. FIG. 13A illustrates the recycling reflective polarizer 1206 between the microlens 1202 and the LED 1204. This implementation is similar to the LED assembly described in connection with FIG. 12 and will operate similarly. The LED 1204 may provide a cone angle of 120 degrees. The recycling reflective polarizer 1206 may be positioned between the LED 1204 and the microlens 1202. By positioning the recycling reflective polarizer 1206 in contact with the LED 1204, light losses to the sides are reduced because the distance the light travels before being recycled is reduced. Thus, the recycled light is returned to the LED emitting surface 1302 where it may be depolarized and re-emitted. In some embodiments, the LED emitting surface 1302 may be rough surface which may depolarize the light to an unpolarized state which allows the light returned to the recycling reflective polarizer 1206 to be recycled again. The microlens 1202 collimates the light after polarization recycling at the LED 1204. The LED 1204, recycling reflective polarizer 1206, and microlens 1202 can be made as an aligned assembly that outputs polarized light with high efficiency/brightness.

FIG. 13B illustrates a recycling reflective polarizer 1206a positioned above the microlens 1202 such that the unpolarized light from the LED 1204 passes through the microlens 1202 before being incident on the recycling reflective polarizer 1206a. The unpolarized light is partially reflected by the recycling reflective polarizer 1206a to be converted and recycled. Advantageously, including the recycling reflective polarizer 1206a above the microlens 1202 allows the recycling reflective polarizer 1206a to be retrofitted onto the microlens 1202 without disassembling the microlens 1202 from the LED 1204. The LED 1204 may provide a cone angle of 120 degrees. The microlens 1202 may collimate the light after polarization recycling at the LED 1204. Positioning the recycling reflective polarizer 1206a after the microlens 1202 may reduce light losses to the sides because the light is more collimated (e.g. smaller cone angle). This insures that a majority of the recycled light is returned to the LED emitting surface 1302 and the area surrounding the LED emitting surface 1302 where it can be depolarized and re-emitted. The LED emitting surface 1302 and/or the area surrounding the LED emitting surface 1302 may be a rough surface which may depolarize the reflected light from the recycling reflective polarizer 1206a.

FIG. 13C illustrates a polarization recycling system similar to FIG. 13A however there is a separation distance 1304 between the LED 1204 and the recycling reflective polarizer 1206. As illustrated, as the separation distance 1304 is increased, light leakage out of the sides may occur. However, if the separation distance 1304 is near zero, the light leakage out of the sides is greatly reduced. Thus, it is advantageous for the separation distance 1304 to be as close to zero as possible as illustrated in FIG. 13A. The microlens 1202 may include low birefringence so the polarization state transmitted by the recycling reflective polarizer 1206 may be preserved.

FIG. 13D illustrates an operation of a polarization recycling system similar to FIG. 13B. When the recycling reflective polarizer 1206a is positioned after the lens 1202 where the cone angle is reduced, a portion of the light can still be polarization recycled. But an amount of light may be lost to the sides. As illustrated, light rays 1308 may be directed away from the LED emitting surface 1302 which may result in unwanted light loss in the recycling system. In this system, the better the lens 1202 is at collimating the light from the LED 1204, the larger the portion of the light can be polarization recycled. Positioning the recycling reflective polarizer 1206a after the lens 1202 may enable a birefringent lens to be used which could decrease costs. FIG. 13E illustrates a polarization recycling system similar to FIG. 13B except with a curved reflective polarizer. Using the curved reflective polarizer enables the recycled light to be pointed back into the lens 1202 so that losses to the side are reduced. The curved recycling reflective polarizer 1206b can include a simple curve or a spherical/aspheric curve. The curved recycling reflective polarizer 1206b can include a compound parabolic reflector. The curved recycling reflective polarizer 1206b may alleviate the light loss discussed in connection with FIG. 13D.

FIG. 13F illustrates the polarization recycling system of FIG. 13A with an additional polarization conversion film 1306. Polarization conversion film 1306 can be a quarter wave film or a depolarizing film. Examples of depolarizing films may be found in Shizuki Sasaki, Mariko Udono, and Yasuhiro Koike, “Real-color displays realized by randomized polarization,” Appl. Opt. 60, 3108-3113 (2021) which is hereby incorporated by reference in its entirety. A quarter wave film may change the recycled light to circularly polarized light which is then changed to the opposite polarization state after being reflected by the surface of the LED 1204. A depolarizing film converts polarized light to unpolarized light.

FIG. 13G illustrates the polarization recycling system of FIG. 13B utilizing a catadioptric lens 1202a. The catadioptric lens 1202a may provide high angle collection and thus higher efficiency. The catadioptric lens 1202a may include a planar output surface for supporting polarization components. The planar output surface may be flat or have a low curvature. There may be other optical layers on the output surface of the catadioptric lens 1202a. The catadioptric lens 1202a may include refracting/reflecting surfaces for lens optimization such as reducing the cone angle of the emitted light. A catadioptric lens 1202a may have a thinner form factor than other lens solutions.

The concepts disclosed in at least one of FIG. 13A-13G may be utilized together. Further, these devices may include other features. In some embodiments, the LED emitting surface 1302 is rough so that the reflected recycled light is depolarized. The roughness may be greater than 10 Angstroms. In some embodiments, the surface surrounding the LED emitting surface 1302 may also be rough to depolarize and a reflective polarizer 1206b may be included to efficiently reflect the recycled light. The surrounding surface around the LED emitting surface 1302 may be a diffusive white reflector. In some embodiments, the LED 1204 may be mounted inside a reflective hole (or tunnel) to reflect the light back toward the lens 1202 and the LED emitting surface 1302. The reflective polarizer 1206, 1206a, 1206b may have an extinction ratio of greater than 100:1 so that a relatively pure polarization state is provided in the illuminating light. The reflective polarizer 1206, 1206a, 1206b may transmit 90% of the parallel polarization over the visible spectrum. The reflective polarizer 1206, 1206a, 1206b may have an extinction ratio of 1800:1. The reflective polarizer 1206, 1206a, 1206b may include an adhesive on one side for mounting and for depolarizing. The reflective polarizer 1206, 1206a, 1206b may have a thickness of 62 μm including adhesive. In some embodiments, the reflective polarizer 1206, 1206a, 1206b may be a reflective circular polarizer. In some embodiments, the reflective polarizer 1206, 1206a, 1206b may be an image quality polarizer enhanced such as IQP-E as manufactured by the 3M Company headquartered in Minnesota, USA. The IQP-E may eliminate the addition of an absorptive polarizer and thereby increase the brightness by greater than 36%.

In some embodiments, the reflective polarizer 1206, 1206a, 1206b may be a wire grid film. The wire grid film may transmit 90% of the parallel polarization over the visible spectrum. The wire grid film may be adhesive on one side. The wire grid film may have a thickness of 100 μm with the adhesive. The wire grid film may increase overall brightness of the LED by 20-25%.

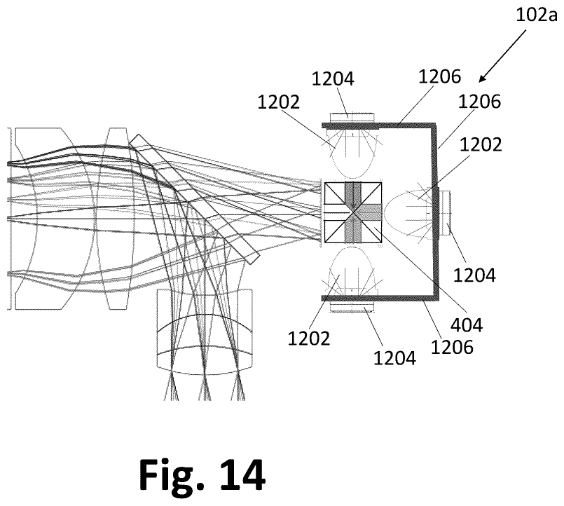

FIG. 14 illustrates a polarization recycling system integrated into a projector with multiple LEDs. The projector is similar to the projector discussed in connection with FIGS. 1-3. To insure that all the LEDs 1204 are polarized with the same state and to make the reflective polarizer 1206 easier to handle, the recycling reflective polarizer 1206 may be a single rectangular piece which can be used to cover the backs of all 3 LEDs 1204. The recycling reflective polarizer 1206 may include alignment features cut into the recycling reflective polarizer 1206. The light source 102a includes multiple LEDs 1204, recycling reflective polarizers 1206 and lenses 1202. The light source 102a may be similar to the light source discussed in connection with FIG. 13A. The light source 102a may also include systems described in connection with FIGS. 13B-13F. For example, the recycling reflective polarizer may be disposed on top of the lens 1202 as described in connection with FIG. 13B.

In some embodiments, polarization recycling may increase brightness through the lens 1202 by 20%. In embodiments where the reflective polarizer 1206 is a reflective circular polarizer, recycling improved brightness by 35% which may be due to the depolarizing that occurs at the LED emitting surface 1302. The illumination pattern may be unchanged in embodiments including the reflective polarizer 1206 between the LED 1204 and the lens 1202. The illumination pattern may be unchanged by the light combiner 404. Various examples of brightness increases may be found in Appendix A on pages 6, 8, and 9.

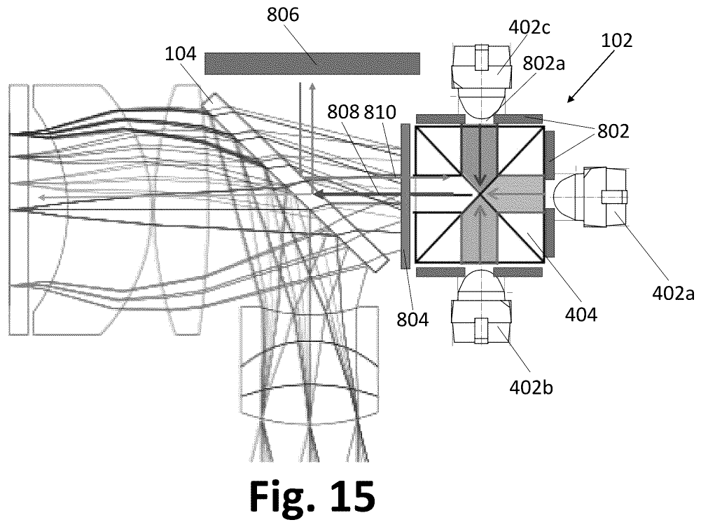

FIG. 15 illustrates a schematic of a projector including a polarized light recycling system in accordance with an embodiment of the invention. This projector shares many features with the projector described in connection with FIGS. 1-4. The description of these features above are applicable to this projector as well and will not be repeated. The light source may include a light combiner 404 and a first LED 402a, a second LED 402b, and a third LED 402c positioned on different faces of the light combiner 404. Mirrors 802 may be positioned on each of the faces of the light combiner 404 that are associated with LEDs 402a, 402b and 402c. The mirrors 802 may surround the light combiner 404 with apertures 802a which correspond to the positioning of the first LED 402a, the second LED 402b, and the third LED 402c so that the light from the LEDs can enter the light combiner 404 to provide light 202. The projector also includes a quarter wave plate 804 positioned between the light combiner 404 and the reflective polarizer 104. The projector may further includes a mirror 806 positioned above the reflective polarizer 104.

In the embodiment shown in FIG. 15, light 808 provided by the LEDs in light source 102 is unpolarized so that it is unaffected by passing through quarter wave plate 804 when it exits the light combiner 404. Reflective polarizer 104 reflects one polarization while transmitting the other polarization, where both of these polarizations are linear polarizations. The reflected portion of light 808 is then reflected by mirror 806 to form light 810 which is again reflected by reflective polarizer 104 so that light 810 passes back through the quarter wave plate 804. In passing through the quarter wave plate 804, light 810 is converted to circular polarization. The circularly polarized light 810 is reflected or transmitted by the dichroic coating in the light combiner 404 based on its color, so that it is directed toward the LED which originated the light 808. Mirror 802 then reflects light 810 which reverses the circular polarization. This light with reversed circular polarization is then reflected or transmitted again according to color by the dichroic coating in the light combiner 404 so that it passes back through the quarter wave plate 804. In passing through the quarter wave plate 804, the polarization is converted from circular polarization to linear polarization but with a polarization that is opposite to the polarization of light 810 so that it is transmitted by the reflective polarizer 104. As a result, portions of light 808 with polarization that were not originally transmitted by the reflective polarizer 104 are converted to the polarization that is transmitted and efficiency of the light source is enhanced. In some embodiments, the dichroic coating in the light combiner 404 may be a multilayer stack which may have some effect on the polarization of the light reflected from the mirror 802 depending on the incident angle. Since the incident light has a fairly narrow angle beam, the effect should not be too significant.

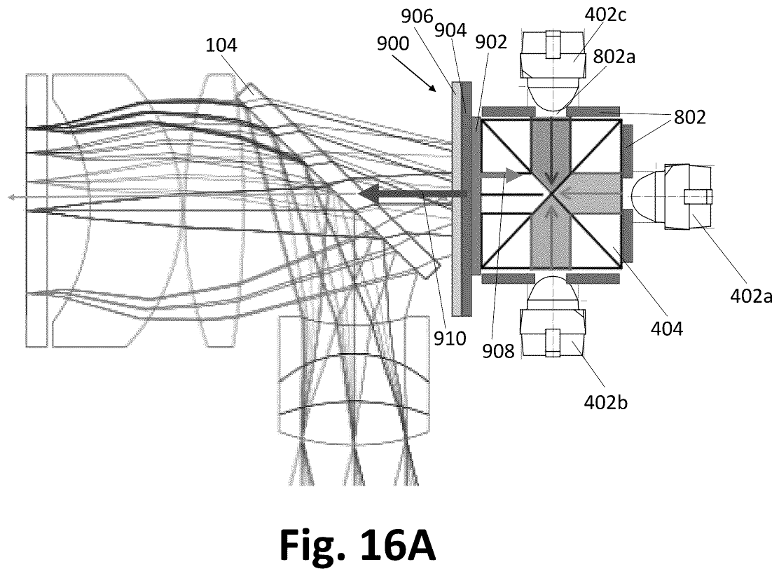

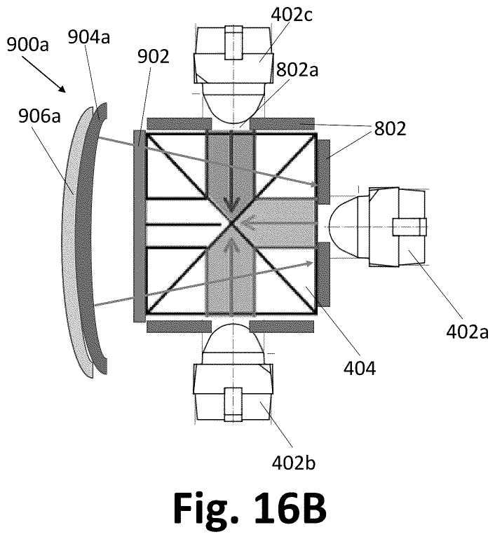

FIG. 16A illustrates a schematic of a projector including a light recycling system in accordance with an embodiment of the invention. This projector shares many features with the projector described in connection with FIGS. 1-4. The description of these features above are applicable to this projector as well and will not be repeated. The light source may include a light combiner 404 and a first LED 402a, a second LED 402b, and a third LED 402c positioned on different faces of the light combiner 404. Mirrors 802 may be positioned on each of the faces of the light combiner 404. The mirrors 802 may surround the light combiner 404 with apertures 802a which correspond to the positioning of the first LED 402a, the second LED 402b, and the third LED 402c so that light from the LEDs can enter the light combiner 404. An optical stack 900 is positioned between the light combiner 404 and a first reflective polarizer 104. The optical stack 900 may include a quarter waveplate 902, a second reflective polarizer 904, and a diffuser 906. In a preferred embodiment of the invention, the second reflective polarizer 904 is positioned between the quarter waveplate 902 and the diffuser 906 with the quarter waveplate 902 being positioned closest to the light combiner 404.

The LEDS (402a, 402b and 402c) in the light source 102 provide light that is unpolarized. The unpolarized light 910 passes through the quarter wave plate 902 without being affected. The second reflective polarizer 904 then reflects one polarization of the light 908 while transmitting the other polarization of the light, where both of these polarizations are linear. The reflected linear polarized light 908 then passes back through the quarter wave plate 902 and is converted to circularly polarized light. The circularly polarized light is reflected or transmitted by the dichroic coating in the light combiner 404 so that the light is directed toward to the LED where the light originated. The circularly polarized light is reflected by the mirror 802 and converted to a reversed circular polarization in the process. The reversed circular polarization light is reflected or transmitted by the dichroic coating according to color so the light then passes back through the quarter wave plate 902. In passing through the quarter wave plate, the light is converted from circularly polarized to linear polarized light. But since the light was of a reversed circular polarization, the linear polarization is of the opposite polarization so that it is transmitted by the second reflective polarizer 904. As such, light from the light source 102 that was initially reflected by the reflective polarizer 104 and would have been wasted, is now recycled and efficiency of the light source 102 is enhanced. By positioning the diffuser 906 after the reflective polarizer 904 in the stack 900, light is prevented from passing through the diffuser twice and the cone angle of the light 202 is preserved.

FIG. 16B illustrates a light recycling system in accordance with an embodiment of the invention. This projector shares many features with the projector described in connection with FIG. 16A. The description of these features above are applicable to this projector as well and will not be repeated. As with FIG. 16A, the light recycling system may include an optical stack 900a positioned between the light combiner 404 and a first reflective polarizer 104. The optical stack 900a may include a quarter waveplate 902, a second reflective polarizer 904a and a diffuser 906a. The second reflective polarizer 904a may be positioned between the quarter waveplate 902 and the diffuser 906a with the quarter waveplate 902 being positioned closest to the light combiner 404. As illustrated, the second reflective polarizer 904a may be curved and the diffuser 906a may be conformally coated on the curved second reflective polarizer 904a which may minimize Fresnel surface losses. Advantageously, the curved second reflective polarizer 904a may focus the recycled light thereby reducing the cone angle of the recycled light.

Although only a few embodiments of the invention have been described in detail, it should be appreciated that the invention may be implemented in many other forms without departing from the spirit or scope of the invention. For example, embodiments such as enumerated below are contemplated:

Item 1. A projector device for displaying an image comprising:
a light source;
a first reflective polarizer;
a reflective image modulator;
a set of one or more lenses positioned along a first optical axis between the first reflective polarizer and the reflective image modulator; and
a display system,
wherein the light source outputs illuminating light which at least partially passes through the first reflective polarizer and is focused by the set of one or more lenses to provide telecentric illumination with a narrow cone angle onto the reflective image modulator, and
wherein the illuminating light is reflected by the reflective image modulator to form image containing light which is focused by the set of one or more lenses, and wherein the image containing light is reflected by the first reflective polarizer to provide an input to the display system.

Item 2. The projector device of item 1, wherein the illuminating light passes through the set of one or more lenses to focus onto the reflective image modulator and the image containing light passes back through the set of one or more lenses to provide a focused image as an input to the display system.

Item 3. The projector device of item 1, wherein the light source includes one or more LEDs each with cone angles of less than +/−15 degrees.

Item 4. The projector device of item 1, wherein the light source includes one or more lasers.

Item 5. The projector device of item 1, wherein the light source includes a diffuser to increase a cone angle of the illuminating light to match a cone angle of the image containing light at the reflective polarizer.

Item 6. The projector device of item 5, wherein the diffuser is a holographic diffuser.

Item 7. The projector device of item 6, wherein the holographic diffuser is a flat top diffuser that provides a rectangular illumination pattern.

Item 8. The projector device of item 7, wherein the illumination pattern substantially matches an active area of the reflective image modulator.

Item 9. The projector device of item 1, wherein the light source includes an X-cube with multiple light sources that are directed by the X-cube to provide a common path and common cone angle of illuminating light for all the light sources at the reflective polarizer.

Item 10. The projector device of item 9, wherein the multiple light sources are red, green and blue LEDs and the X-cube includes dichroic coatings.

Item 11. The projector device of item 10, wherein the projector device includes a controller that sequentially operates the LEDs to provide sequential red, green, and blue illumination of the reflective image modulator.

Item 12. The projector device of item 11, wherein the controller adjusts the brightness and duty cycle of the LEDs to produce colors perceived by a user that are associated with portions of the image.

Item 13. The projector device of item 1, wherein the reflective polarizer is a wire grid polarizer.

Item 14. The projector device of item 1, wherein the reflective polarizer is oriented at 45 degrees to a common optical axis between the light source and the reflective image modulator thereby folding the optical path of the image containing light.

Item 15. The projector device of item 14, wherein the reflective polarizer is oriented with the reflective side facing the reflective image modulator.

Item 16. The projector device of item 1, wherein the display system includes a waveguide.

Item 17. The projector device of item 1, further comprising a set of one or more output lenses positioned along a second optical axis on the folded optical path for the image containing light between the first reflective polarizer and the display system.

Item 18. The projector device of item 17, wherein the set of one or more lenses and the set of one or more output lenses together collimate the image containing light from said reflective image modulator and project light reflected from each pixel of the reflective image modulator into a unique portion of the displayed FOV.

Item 19. The projector device of item 17, wherein the first optical axis and the second optical axis are perpendicular to each other.

Item 20. The projector device of item 17, wherein the set of one or more lenses and the set of one or more output lenses include at least one selected from the group of a spherical surface, an aspheric surface, and a diffractive optical surface.

Item 21. The projector device of item 1, wherein the first reflective polarizer reflects light of a first polarization and transmits light of a second polarization, and wherein the reflective image modulator transforms light from light of the second polarization to light of the first polarization in correspondence to image content.

Item 22. The projector device of item 1, wherein the light source outputs light with P polarization, the first reflective polarizer transmits the P-polarized light, the reflective image modulator transforms the P-polarized light into S-polarized light in correspondence with image content which is reflected by the first reflective polarizer.

Item 23. The projector device of item 1, wherein the light source outputs light with S polarization, the first reflective polarizer transmits the S-polarized light, the reflective image modulator transforms the S-polarized light into P-polarized light in correspondence with image content which is reflected by the first reflective polarizer.

Item 24. The projector device of item 1, wherein the light source is configured to output red, green, and blue light.

Item 25. The projector device of item 24, wherein the light source comprises a red LED, a green LED, and a blue LED.

Item 26. The projector device of item 25, wherein the light source further comprises a light combiner and wherein the red LED, the green LED, and the blue LED are positioned to output different colors of light onto different faces of the light combiner.

Item 27. The projector device of item 26, wherein the light combiner is an X-cube.

Item 28. The projector device of item 27, wherein the combined different colors of light are output from a unique face of the light combiner as white light.

Item 29. The projector device of item 26, further comprising a diffuser positioned between the light combiner and the first reflective polarizer.

Item 30. The projector device of item 29, wherein the diffuser is attached to the output face of the light combiner.

Item 31. The projector device of item 26, further comprising an absorptive polarizer disposed on the output face of the light combiner.

Item 32. The projector device of item 26, further comprising:
a quarter waveplate positioned between the first reflective polarizer and the light combiner;
a first mirror positioned above the first reflective polarizer; and
a plurality of mirrors surrounding the light combiner with apertures which correspond to the positioning of the red LED, the green LED, and the blue LED,
wherein the light is:
   rotated within the quarter waveplate;
   at least partially reflected off the first reflective polarizer, wherein the first reflective polarizer transmits a first linear polarization of light and reflects a second linear polarization of light;
   reflected off the first mirror;
   reflected again off the first reflective polarizer;
   rotated within the quarter waveplate into circularly polarized light;
   reentered into the light combiner where the light is reflected off at least one of the plurality of mirrors reversing the direction of the circularly polarized light;
   rotated within the quarter waveplate into the second linear polarization of light; and
   transmitted through the first reflective polarizer.

Item 33. The projector device of item 26, further comprising:
a film stack comprising: a diffuser, a second reflective polarizer, and a quarter waveplate positioned between the light combiner and the first reflective polarizer; and
a plurality of mirrors surrounding the light combiner with apertures which correspond to the positioning of the red LED, the green LED, and the blue LED,
wherein the light is:
   rotated within the quarter waveplate,
   at least partially reflected off the second reflective polarizer, wherein the second reflective polarizer is configured to transmits a first linear polarization of light and reflects a second linear polarization of light,
   rotated within the quarter waveplate into circularly polarized light,
   reentered into the light combiner where the light is reflected off at least one of the plurality of mirrors reversing the direction of the circularly polarized light,
   rotated within the quarter waveplate into the first linear polarization of light,
   transmitted through the second reflective polarizer,
   diffused through the diffuser, and
   passed through the first reflective polarizer.

Item 34. The projector device of item 33, wherein the first reflective polarizer and the second reflective polarizer are configured to transmit the same polarization of light.

Item 35. The projector device of item 33, wherein the first reflective polarizer and the second reflective polarizer are configured to reflect the same polarization of light.

Item 36. The projector device of item 33, wherein the second reflective polarizer is curved and the diffuser is conformally coated to the curved second reflective polarizer.

Item 37. The projector device of item 1, wherein the reflective image modulator comprises a liquid crystal on silicon (LCoS) spatial light modulator.

Item 38. The projector device of item 1, further comprising an absorptive polarizer positioned between the light source and the first reflective polarizer.

Item 39. The projector device of item 38, wherein the absorptive polarizer is positioned on a surface of the first reflective polarizer facing the light source.

Item 40. The projector device of item 38, wherein the first reflective polarizer and absorptive polarizer are configured to transmit the same polarization of light.

Item 41. The projector device of item 1, further comprising an absorptive polarizer positioned in the path of the image containing light that is reflected by the first reflective polarizer.

Item 42. The projector device of item 41, wherein the absorptive polarizer is configured to transmit the same polarization of light as the reflective polarizer is configured to reflect.

Item 43. The projector device of item 1, wherein the display system comprises a waveguide including an input grating configured to input image containing light into total internal reflection within the waveguide.

Item 44. A device for providing polarized light comprising:
a light source which outputs unpolarized light;
a reflecting surface associated with the light source that also at least partially depolarizes; and
a reflective polarizer,
wherein a first portion of the unpolarized light from the light source includes a first polarization state that is transmitted by the reflective polarizer and a second portion of the unpolarized light including a second polarization state that is reflected by the reflective polarizer,
wherein the reflected second portion is then reflected and depolarized by the reflecting surface to form recycled light comprising light with both the first polarization state and the second polarization state, and
wherein portions of the recycled light are then transmitted and reflected by the reflective polarizer in correspondence to their polarization state thereby increasing the transmitted light with the first polarization state.

Item 45. The device of item 44, further comprising a polarization conversion film between the light source and the reflective polarizer.

Item 46. The device of item 45, wherein the polarization conversion film is a quarter wave film.

Item 47. The device of item 45, wherein the polarization conversion film is a depolarizing film.

Item 48. The device of item 44, wherein the light source is an LED.

Item 49. The device of item 44, further comprising a lens.

Item 50. The device of item 49, wherein the reflective polarizer is positioned between the light source and the lens.

Item 51. The device of item 49, wherein the reflective polarizer is positioned above the lens.

Item 52. The device of item 51, wherein the reflective polarizer is curved.

Item 53. The device of item 52, wherein the curve is a simple curve.

Item 54. The device of item 52, wherein the curve is a spherical curve.

Item 55. The device of item 52, wherein the curve is an aspheric curve.

Item 56. The device of item 49, wherein the lens is a compound parabolic reflector.

Item 57. The device of item 49, wherein the light source and lens are a bonded light assembly and the light source is aligned relative to the lens.

Item 58. The device of item 51, wherein the lens is birefringent.

Item 59. The device of item 49, wherein the lens is a catadioptric lens.

Item 60. The device of item 44, wherein the reflective polarizer is positioned within 100 microns of the light source.

Item 61. The device of item 44, wherein the reflecting surface has a surface roughness that is greater than 100 Angstroms.

Item 62. The device of item 44, wherein the reflective polarizer has an extinction ratio of greater than 100:1.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A projector device for displaying an image comprising:
a light source;
a first reflective polarizer;
a reflective image modulator;
a set of one or more lenses positioned along a first optical axis between the first reflective polarizer and the reflective image modulator; and
a display system,
wherein the light source outputs illuminating light which at least partially passes through the first reflective polarizer and is focused by the set of one or more lenses to provide telecentric illumination with a narrow cone angle onto the reflective image modulator, and
wherein the illuminating light is reflected by the reflective image modulator to form image containing light which is focused by the set of one or more lenses, and wherein the image containing light is reflected by the first reflective polarizer to provide an input to the display system.

2. The projector device of claim 1, wherein the illuminating light passes through the set of one or more lenses to focus onto the reflective image modulator and the image containing light passes back through the set of one or more lenses to provide a focused image as an input to the display system.

3. The projector device of claim 1, wherein the light source includes one or more LEDs each with cone angles of less than +/−15 degrees.

4. The projector device of claim 1, wherein the light source includes one or more lasers.

5. The projector device of claim 1, wherein the light source includes a diffuser to increase a cone angle of the illuminating light to match a cone angle of the image containing light at the reflective polarizer.

6. The projector device of claim 5, wherein the diffuser is a holographic diffuser.

7. The projector device of claim 6, wherein the holographic diffuser is a flat top diffuser that provides a rectangular illumination pattern.

8. The projector device of claim 7, wherein the illumination pattern substantially matches an active area of the reflective image modulator.

9. The projector device of claim 1, wherein the light source includes an X-cube with multiple light sources that are directed by the X-cube to provide a common path and common cone angle of illuminating light for all the light sources at the reflective polarizer.

10. The projector device of claim 1, wherein the reflective polarizer is a wire grid polarizer.

11. The projector device of claim 1, wherein the reflective polarizer is oriented at 45 degrees to a common optical axis between the light source and the reflective image modulator thereby folding the optical path of the image containing light.

12. The projector device of claim 11, wherein the reflective polarizer is oriented with the reflective side facing the reflective image modulator.

13. The projector device of claim 1, wherein the first reflective polarizer reflects light of a first polarization and transmits light of a second polarization, and wherein the reflective image modulator transforms light from light of the second polarization to light of the first polarization in correspondence to image content.

14. The projector device of claim 1, wherein the light source outputs light with P polarization, the first reflective polarizer transmits the P-polarized light, the reflective image modulator transforms the P-polarized light into S-polarized light in correspondence with image content which is reflected by the first reflective polarizer.

15. The projector device of claim 1, wherein the light source outputs light with S polarization, the first reflective polarizer transmits the S-polarized light, the reflective image modulator transforms the S-polarized light into P-polarized light in correspondence with image content which is reflected by the first reflective polarizer.

16. The projector device of claim 1, wherein the light source is configured to output red, green, and blue light.

17. The projector device of claim 16, wherein the light source comprises a red LED, a green LED, and a blue LED.

18. The projector device of claim 17, wherein the light source further comprises a light combiner and wherein the red LED, the green LED, and the blue LED are positioned to output different colors of light onto different faces of the light combiner.

19. The projector device of claim 18, further comprising:
a quarter waveplate positioned between the first reflective polarizer and the light combiner;
a first mirror positioned above the first reflective polarizer; and
a plurality of mirrors surrounding the light combiner with apertures which correspond to the positioning of the red LED, the green LED, and the blue LED,
wherein the light is:
rotated within the quarter waveplate;
at least partially reflected off the first reflective polarizer, wherein the first reflective polarizer transmits a first linear polarization of light and reflects a second linear polarization of light;
reflected off the first mirror;
reflected again off the first reflective polarizer;
rotated within the quarter waveplate into circularly polarized light;
reentered into the light combiner where the light is reflected off at least one of the plurality of mirrors reversing the direction of the circularly polarized light;
rotated within the quarter waveplate into the second linear polarization of light; and
transmitted through the first reflective polarizer.

20. The projector device of claim 18, further comprising:
a film stack comprising: a diffuser, a second reflective polarizer, and a quarter waveplate positioned between the light combiner and the first reflective polarizer; and
a plurality of mirrors surrounding the light combiner with apertures which correspond to the positioning of the red LED, the green LED, and the blue LED,
wherein the light is:
rotated within the quarter waveplate;
at least partially reflected off the second reflective polarizer, wherein the second reflective polarizer is configured to transmits a first linear polarization of light and reflects a second linear polarization of light;
rotated within the quarter waveplate into circularly polarized light;
reentered into the light combiner where the light is reflected off at least one of the plurality of mirrors reversing the direction of the circularly polarized light;
rotated within the quarter waveplate into the first linear polarization of light;
transmitted through the second reflective polarizer;
diffused through the diffuser; and
passed through the first reflective polarizer.
